(19) United States
(12) Patent Application Publication
(10) Pub. No.: US 2011/0001030 A1
(43) Pub. Date: Jan. 6, 2011

(54) INSTALLATION BRACKET

(75) Inventors: Erwin Hochreiter, Klagenfurt (AT); Antonio Gamero, Klagenfurt (AT); Günter Koschier, Launsdorf (AT); Heinz Rankl, Passering (AT)

Correspondence Address: KUSNER & JAFFE;HIGHLAND PLACE SUITE 310, 6151 WILSON MILLS ROAD, HIGHLAND HEIGHTS, OH, 44143, US

(73) Assignee: GREENoneTEC Solarindustrie GmbH

(21) Appl. No.: 12/777,343

(22) Filed: May 11, 2010

(30) Foreign Application Priority Data
Jul. 1, 2009 (EP) 09 008 598.6

(51) Int. Cl. F16M 13/00

(52) U.S. Cl. 248/316.1

(57) ABSTRACT

The object of the invention is an installation bracket for mounting a first component on a second component, especially an installation bracket for mounting a solar collector on a rail that, in turn, is mounted on part of a building such as, for example, a roof.

### FIELD OF THE INVENTION

The invention relates to an installation bracket for mounting a first component on a second component, especially an installation bracket for mounting a solar collector on a rail that, in turn, is mounted on part of a building such as, for example, a roof.

### BACKGROUND OF THE INVENTION

The invention insofar may form part of a complex installation and mounting system for solar collectors (particularly hot water and photovoltaic collectors) that are installed, for example, on a roof, in a roof, on or in a building facade.

The aforementioned collectors frequently feature a flat cuboid housing with dimensions (width, length, height) of about 100×200×10 cm. They are known as so-called frame collectors or tray collectors.

Mounting systems known so far are largely rigid and cannot make allowances for local constructive standards. Consequently, collectors are frequently mounted in an askew and optically insufficient fashion. Another disadvantage is that known mounting means can only be installed with the aid of different tools. This creates additional problems for the installers, particularly during roof and façade installations.

Installation brackets of the aforementioned type are known, for example, from the following publications: DE 10 2007 053 376 A1, DE 20 2006 018 586 U1 and AT 412 909 B.

The object of the invention consists of disclosing a constructively simple installation bracket for mounting a first component to a second component, wherein the bracket preferably can be installed without tools or with a simple tool and arranged in the desired installation position on-site.

### SUMMARY OF THE INVENTION

The invention is based on the following consideration:

The installation of a collector on rails provides different advantages such as, among other things, being able to arrange installation brackets for the collectors at different positions along the rails. This results in a certain variability during the installation. However, it is disadvantageous that known mounting brackets are installed on the rails at defined positions. This limits the possibilities for an exact positioning. However, this exact positioning is important, particularly when several collectors need to be adjusted adjacent to one another.

An installation bracket according to the invention, in contrast, is realized in such a way that it has two functional ends. A first functional end serves for detachably mounting a first component such as, for example, the collector and a second functional end serves for detachably mounting the installation bracket on a second component such as, for example, the aforementioned rail. In this case, the second functional end is designed and realized in such a way that the installation bracket can be adjusted and fixed at any location of the rail while the first functional end also allows an individual adjustment of a corresponding bracket section for fixing the first component (the collector). This not only allows a relative adjustment of the rail and the installation bracket, but also an adjustment of the installation bracket and the collector and therefore an adjustability in at least two directions of the coordinate system. Other measures that are discussed in detail below and concern, in particular, the design of a corresponding control element furthermore make it possible to achieve an at least partial adjustability in the direction of a third coordinate (z-direction).

In its most general embodiment, the invention pertains to an installation bracket for mounting a first component on a second component with the following characteristics:

a base body,

a control element with a first end section and a second end section,

the control element penetrates the base body,

a second locking element for mounting the installation bracket on the second component is arranged on the second end section of the control element,

a first locking element for fixing a clamp, by means of which the first component is mounted on the installation bracket, is arranged on the first end section of the control element,

the clamp is supported on at least one bearing that is arranged on the opposite side of the clamp referred to the first locking element.

Consequently, the at least one bearing forms a counter bearing to the first locking element when the clamp is assembled and fixed.

The clamp itself serves for overlapping the first component (for example the collector) and for fixing the collector after adjusting the other components of the installation bracket.

The only component of the installation bracket that may have to be adjusted with a tool is the control element. Depending on its design, this can be realized with a simple screwdriver or hexagon wrench.

Due to the inventive design, the installation bracket can be fixed to the second component by bracing the second locking element relative to the second component without requiring a tool.

As described in greater detail below with reference to one exemplary embodiment, the second locking element can be inserted into a corresponding slot-shaped opening of the second component (the rail) and then turned by 90° until corresponding sections (lateral wings) of the second locking element are positioned such that they protrude over the aforementioned slot-shaped opening on both sides. Said wing sections can then be guided against corresponding sections of the second component (the rail) by displacing the second locking element along the central longitudinal axis of the control element in order to realize the desired mounting.

Due to the at least one aforementioned bearing and the clamp being supported thereon, a counter bearing for the installation bracket is created in order to ensure that the second locking element does not shift from its installation position due to gravitation, wind load or the like.

In this context, it should be noted that the first component to be mounted (the collector) rests on the first component (the rail) or, in other words: the installation bracket is mounted on the rail laterally adjacent to the collector and the clamp protrudes over the collector(s) to be mounted on one or two sides before it is fixed onto the collector (on the upper side of the collector, facing the sun).

According to one embodiment, the at least one bearing forms part of the base body. This makes it possible to reduce the number of components of the installation bracket.

With consideration of the mechanical loads that act upon a collector after its installation, it needs to be ensured that the collector is, as far as possible, fixed on the rail and on the installation bracket without any play. To this end, one embodiment of the invention proposes to provide at least two bearings for the clamp that are spaced apart from one another. These bearings (counter bearings) are advantageously arranged on opposite sides of the control element, i.e., spaced apart from one another in the longitudinal direction of the corresponding rail (the second component) and on opposite sides of the control element in the installed position of the installation bracket.

In order to mount components of different sizes with one and the same installation bracket, the second locking element may be arranged such that it can be adjusted along the second end section of the control element. This adjustability is an adjustability in the direction of the central longitudinal axis of the control element or, in other words: an adjustability perpendicular to the axial direction of the second component (the rail). This makes it possible, in particular, to compensate different structural heights of different collectors.

To this end, the invention concretely proposes to realize the second locking element with an opening, wherein the opening features a thread-like wall section, into which the control element engages with a corresponding threaded section. In this case, the opening may be realized in the form of a blind hole with a thread or a slot opening with opposite thread-like wall sections. The latter-mentioned design is discussed with reference to the following exemplary embodiment.

If the second locking element features two wings that are offset relative to one another by 180°, these wings can be realized with snap elements that extend in the direction of the first end section of the control element. These elements may consist of right-angle bends on the ends of the wings or of separately realized tabs or the like.

In order to adjust the installation bracket and to fix the final installation position, one embodiment of the invention proposes to support the control element in a spring-loaded fashion in a section between the base body and the first locking element. Such a spring may consist of a coil spring or a pressure spring. In the installation position, the spring presses the clamp mounted on the control element upward and is supported on the base body with the opposite end. The shape of the clamp depends on the local conditions and the geometry, in particular, of the section, by means of which the first component (the collector) should be fixed. In this case, the clamp may essentially have the shape of a strip that is angled several times. In a side view, this would approximately result, for example, in an S-, Z- or W-shape. The inventive bracket makes it possible to exclusively fix a solar tray collector in the edge region of the transparent cover. The bracket simultaneously fulfills a safety function in case the cover or parts thereof should separate.

The control element may be a pin, a bolt or a screw. When using a screw design, the first locking element is formed, for example, by the head of the screw and/or a corresponding washer while a threaded section on the other end of the screw serves for accommodating the second locking element and therefore for fixing the installation bracket on the second component (the rail).

The base body, as well as the control element, the first and/or second locking element and the clamp, may be made of metal such as, for example, aluminum. The base body can be advantageously manufactured as an extrusion-moulded part. The base body may also be manufactured of plastic with the same method. This applies analogously to the clamp, the locking elements and the control element.

According to another embodiment, the installation bracket is realized in the form of a mirror image, namely referred to an imaginary plane that extends through a central longitudinal axis of the control element. This imaginary plane preferably is a plane that is aligned perpendicular to the axial direction of the rail-shaped second component.

In this embodiment, two collectors (first components) that are spaced apart from one another can be simultaneously fixed with one installation bracket. The clamp overlaps one collector in one direction and a second collector in an opposite direction that is offset relative to the first direction by 180°. Each collector usually requires 4 installation brackets. When using this “double bracket,” it suffices to provide 6 installation brackets for 2 collectors.

During the installation of collectors that lie on the end of a collector array, in contrast, it suffices to utilize an installation bracket with a clamp that only features one section for fixing one collector.

In this embodiment, the clamp may laterally overlap the second component (the rail) with one free end in an optically advantageous fashion.

In order to securely fix the collectors on the rail by means of the installation brackets and to prevent damages to the collector surface during this process, corresponding materials such as, for example, plastic or metal are used for the clamp.

The end that overlaps the collector may additionally feature a right-angle bend that points in the direction of the second locking element and may consist of a material that ensures adequate adhesion (support) relative to the collector surface such as, for example, caoutchouc or rubber.

Other characteristics of the invention result from the characteristics of the dependent claims and the other application documents.

The invention is described in greater detail below with reference to one exemplary embodiment. This exemplary embodiment concerns an installation bracket for mounting one or more solar collectors on a corresponding rail.

### BRIEF DESCRIPTION OF THE DRAWINGS

FIG. 1 shows a perspective representation of one embodiment of an installation bracket for mounting a collector;

FIG. 2 shows the installation bracket according to FIG. 1 in the form of a side view;

FIG. 3 shows a side view that is offset by 90° referred to the illustration in FIG. 2;

FIG. 4 shows a side view analogous to FIG. 2 of an installation bracket for mounting two collectors that are spaced apart from one another; and

FIG. 5 shows a partial perspective representation of the embodiment according to FIG. 4 from above.

### DETAILED DESCRIPTION OF PREFERRED EMBODIMENT

In the figures, identical components or components that fulfill the same function are identified by the same reference symbols. Positional information such as “top, bottom, right, left” refers to the illustrated installation position.

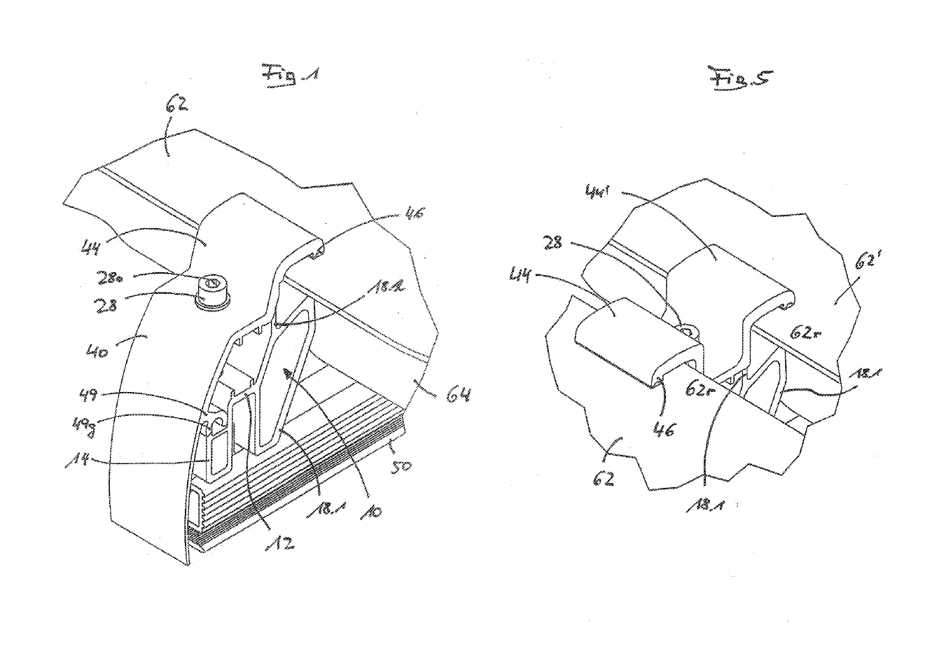

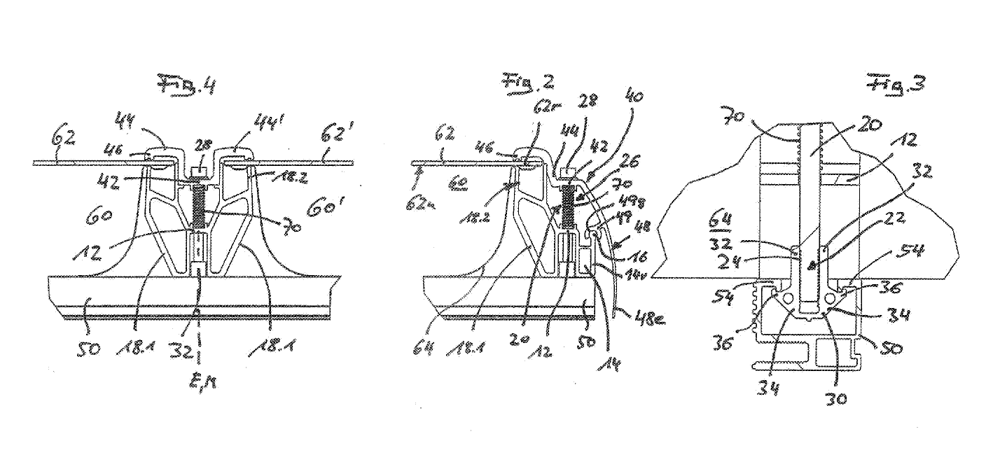

The installation bracket according to FIGS. 1 to 3 is designed as follows: an extrusion-moulded base body of aluminum essentially comprises a horizontally extending web (bar) 12 that approximately lies in the center of the bracket 10 in this case and continues into a box-shaped section 14 on one side (the right side in FIG. 2). On its outer side, the box 14 features an upwardly protruding extension 14v with a thickened section 16 on its end.

The box-shaped section 14 extends parallel to the web 12 on the lower end (FIG. 2) and this section rests on a rail that is referred to as the second component 50 (in the installation position).

On the opposite side referred to the box-shaped section 14, the web 12 is integrally connected to a section 18.1 that has the shape of a ring of sorts in a side view (FIG. 2), wherein a lower end is flattened and once again rests on the rail 50 while a section 18.2 that has the shape of a U in a side view (FIG. 2) follows toward the top. One limb (the left limb in FIG. 2) abuts the underside 62u of an edge section 62r of a glass cover 62 with its free end. The class cover 62 forms part of a collector 60, the edge 62r of which protrudes over a corresponding collector tray 64 (toward the right in FIG. 2).

The web 12 of the base body 10 features an opening that is penetrated by a control element 20 in the form of a screw.

Accordingly, the control element 20 features an external thread 24 on the lower (second) end section 22 and a hat-shaped screw head 28 that forms a first locking element on the opposite first end section 26.

The thread 24 of the control element 20 engages into a second locking element 30, the constructive design of which is illustrated, in particular, in FIG. 3. It comprises two parallel limbs 32 that are spaced apart from one another and the inner wall sections of which are provided with a fluting in order to fix the locking element on the thread 24. This implicitly results in an adjusting option in the axial direction of the control element 20 depending on how far the control element 20 is inserted into the second locking element 30.

On the lower end of the limbs 32, the second locking element 30 features lateral wings 34 that jointly form the approximate shape of a V in a side view (FIG. 3). Snap elements 36 illustrated on the free ends of the wings 34 extend in the direction of the first end section 26 of the control element.

The control element 20 penetrates a clamp 40 along a horizontally extending section 42, wherein this section 42 abuts an underside of the hat-shaped screw head 28.

Referred the axial direction of the rail 50, a hook-shaped section 44 of the clamp follows in one direction (toward the left in FIG. 2), wherein the free end of this section 44 transforms into a part 46 that is bent downward at a right angle and abuts the glass cover 62 of the collector 60 in the installation position. Referred once again to the axial direction of the rail 50, the horizontal section 42 of the clamp transforms into an arc-shaped section 48, the free end 48e of which laterally covers the rail 50, opposite of the hook-shaped section 44.

At the height of the thickened section 16 of the extension 14v of the base body 10, a bridge 49 featuring on its free end a downwardly open fork-like widening 49g that overlaps the thickened section 16 extends from the arc-shaped section 48. The clamp 40 is supported on the thickened section 16 thus acting as a bearing.

Between the horizontal section 42 of the clamp 40 and the web 12, the control element 20 extends coaxial to and within a coil pressure spring 70 that is supported on the web 12 with one (lower) end and abuts the clamp 40 with the other (upper) end.

The mounting of the collector 60 to the rail 50 is discussed below.

After the rail 50 is mounted on a building, the collector 60 is set onto the rail 50. The installation bracket is subsequently installed as follows: the control element 20 with the preinstalled locking element 30 is inserted into a slot-shaped opening 52 of the rail 50. The installation bracket and the locking element 30 is/are then simultaneously turned by 90° until the locking element is positioned transversely as illustrated in FIG. 3. The control element 20 and the locking element 30 are moved upward under the influence of the spring 70 and a counter bearing formed by the section 42, until the locking element 30 abuts corresponding contact surfaces 54 of the rail 50. The installation bracket is now preinstalled. The clamp 40 is aligned in such a way that it overlaps the edge 62r of the collector 60 (FIG. 2) during or after the aforementioned steps. In this case, the clamp 40 is not only supported on the thickened section 16 of the base body 10 with the fork-like widening 49g, but also on one limb (the right limb in FIG. 2) of the U-shaped section 18.2 of the base body 10 with the hook-shaped section 44; and furthermore on the flat coil spring 70 with the horizontal section 42.

Subsequently, the control element 20 or its hat-shaped screw head 28 is screwed into the second locking element 30 until the collector 60 is mounted to the bracket by means of the clamp 40 and the bracket is connected to the rail 50 by means of the locking element 30. The finished installation state results from a synopsis of FIGS. 1 to 3.

During the installation, only a hexagon wrench is required for operating the control element 20 by means of the hexagonal opening 280.

The installation bracket shown serves for installing a collector 60 on the end of a conventional collector array comprising several collectors 60.

The embodiment of an installation bracket illustrated in FIGS. 4 and 5 is provided for mounting collectors 60 that are arranged next to each other.

This embodiment can be distinguished from the embodiment according to FIGS. 1 to 3 in that the base body 10 and the clamp 40 are realized in the form of a mirror image referred to an imaginary plane E, wherein the plane E includes the central longitudinal axis M of the control element 20 as shown in FIG. 4.

In this case, the parts of the installation bracket that extend to both sides of the plane E respectively have a constructive design of the type described above with reference to the annular section 18.1 and the U-shaped section 18.2.

A hook-shaped section 44 of the clamp 40 rests on a glass cover 62 of a first collector 60 while a corresponding hook-shaped section 44′ of the clamp 40 rest on a cover 62′ of a second collector 60′. The installation bracket is fixed on the rail 50 in the same fashion.

The control element 20 and the second locking element 30 also have the same design as in the embodiment according to FIGS. 1 to 3.

According to the figures, a collector is mounted with the described installation brackets only. With respect to a tray collector, this means that (additional) mountings for the tray part can be eliminated. This makes it possible to realize the tray part thinner and lighter because it no longer has a relevant static function. The mounting of the collector in the edge region of the transparent cover provides the additional advantage of securing the cover itself from separating from the collector tray, for example, if an adhesive connection of a glass cover separates over time. The combination of tray collector and installation bracket therefore represents an advantageous structural unit.

Having described the invention, the following is claimed:

1. An installation bracket for mounting a first component on a second component with the following characteristics:
1.1 a base body,
1.2 a control element with a first end section and a second end section,
1.3 the control element penetrates the base body,
1.4 a second locking element for mounting the installation bracket on the second component is arranged on the second end section of the control element,
1.5 a first locking element for fixing a clamp, by means of which the first component is mounted on the installation bracket, is arranged on the first end section of the control element,
1.6 the clamp is supported on at least one bearing that is arranged on the opposite side of the clamp referred to the first locking element.

2. The installation bracket according to claim 1, wherein the at least one bearing forms part of the base body.

3. The installation bracket according to claim 1 with at least two bearings for the clamp that are spaced apart from one another.

4. The installation bracket according to claim 3, wherein the two bearings are arranged on opposite sides of the control element.

5. The installation bracket according to claim 1, wherein the second locking element is arranged such that it can be adjusted along the second end section of the control element.

6. The installation bracket according to claim 5, wherein the second locking element features an opening with a thread-like wall section, into which the control element engages with a corresponding threaded section.

7. The installation bracket according to claim 1, wherein the second locking element features two wings that are offset relative to one another by 180° and realized with snap elements that extend in the direction of the first end section of the control element.

8. The installation bracket according to claim 1, wherein the control element is supported under the influence of a spring in a section between the base body and the first locking element.

9. The installation bracket according to claim 8, wherein the spring is a coil pressure spring.

10. The installation bracket according to claim 1, the clamp of which approximately has a Z-shape or a W-shape in a side view.

11. The installation bracket according to claim 1, wherein at least one of the following components is made of metal: base body, control element, first locking element, second locking element, clamp.

12. The installation bracket according to claim 1, the control element of which is realized in the form of a screw, wherein the first locking element is formed by the head of the screw and/or a corresponding washer.

13. The installation bracket according to claim 1 realized in the form of a mirror image referred to an imaginary plane (E) that extends through the central longitudinal axis (M) of the control element.

14. The installation bracket according to claim 1, wherein the clamp features a right-angle bend that points in the direction of the second locking element on at least its free end.

15. The installation bracket according to claim 1, wherein the clamp laterally covers the second component with one free end.
